(19) United States
(12) Patent Application Publication
(10) Pub. No.: US 2006/0067521 A1
(43) Pub. Date: Mar. 30, 2006

(54) Telephone line powered lamp

(76) Inventors: Earl Muise, Toronto (CA); Mario Bento, Toronto (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/213,895

(22) Filed: Aug. 30, 2005

Related U.S. Application Data
(60) Provisional application No. 60/606,527, filed on Sep. 2, 2004.

(51) Int. Cl. H04M 9/00

(52) U.S. Cl. 379/413

(57) ABSTRACT

A telephone line powered lamp comprising: a body having mounted thereon one or more light emitting diodes (LEDs); a lens cover coupled to the body for focusing light from the LEDs; a telephone jack mounted on the body for receiving a telephone cable for supplying electrical power to the lamp from a telephone line; and, a circuit board mounted within the body and coupled between the telephone jack and the LEDs for regulating the electrical power supplied to the LEDs from the telephone line.

This application claims priority from U.S. Provisional Patent Application No. 60/606,527, filed Sep. 2, 2004, and incorporated herein by reference.

### FIELD OF THE INVENTION

This invention relates to the field of household lamps, and more specifically, to LED lamps powered by telephone lines.

### BACKGROUND OF THE INVENTION

Battery powered flashlights and candles are routinely used as emergency sources of light during electric power system outages.

However, during prolonged power outages, such as that experienced in New York State and Ontario during the summer of 2003, flashlights and candles are inadequate. For example, flashlight batteries may run dead or candles may simply bum out.

A need therefore exists for effective means for providing emergency lighting in homes and small businesses during power outages. Consequently, it is an object of the present invention to obviate or mitigate at least some of the above mentioned disadvantages.

### SUMMARY OF THE INVENTION

According to one aspect of the invention, there is provided a telephone line powered lamp comprising: a body having mounted thereon one or more light emitting diodes (LEDs); a lens cover coupled to the body for focusing light from the LEDs; a telephone jack mounted on the body for receiving a telephone cable for supplying electrical power to the lamp from a telephone line; and, a circuit board mounted within the body and coupled between the telephone jack and the LEDs for regulating the electrical power supplied to the LEDs from the telephone line.

Preferably, the telephone line powered lamp further includes a switch mounted on the body and coupled between the telephone jack and circuit board for switching the electrical power on and off.

Preferably, the circuit board includes one or more of a regulating diode, AC/DC current converting resistors, and voltage reduction resistors.

Preferably, the body is adapted for one or more of wall mounting, table mounting, floor mounting, and hand-held operation.

Preferably, the circuit board includes a capacitor coupled across a series connection of a resistor, a diode, and the LEDs to regulate the electrical power supplied to the LEDs.

Advantageously, the lamp does not require access to the power distribution system.

### BRIEF DESCRIPTION OF THE DRAWINGS

Embodiments of the invention may best be understood by referring to the following description and accompanying drawings. In the description and drawings, like numerals refer to like structures or processes. In the drawings:

FIG. 1 is an exploded perspective view illustrating a telephone line powered lamp in accordance with an embodiment of the invention;

FIG. 2A is a front view illustrating the telephone line powered lamp of FIG. 1 in accordance with an embodiment of the invention;

FIG. 2B is a side view illustrating the telephone line powered lamp of FIG. 1 in accordance with an embodiment of the invention;

FIG. 3A is a perspective view illustrating a circuit board for the telephone line powered lamp of FIG. 1 in accordance with an embodiment of the invention;

FIG. 3B is a plan view illustrating the circuit board in accordance with an embodiment of the invention; and,

FIG. 4 is a schematic diagram illustrating a circuit on the circuit board of FIGS. 3A and 3B in accordance with an alternate embodiment of the invention.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and techniques have not been described or shown in detail in order not to obscure the invention.

The invention was conceived during the major power failure that occurred throughout New York State and Ontario during the summer of 2003. During the power failure, the inventors' flashlight batteries ran dead and their candles burnt out. They were in a panic to try and find a power source to run a light. At that very moment, their telephone rang. Even though the power was off, the telephone still had power. This is because the telephone company has its own power source. The inventors developed means to tap into the telephone line power to run a super bright light emitting diode (“LED”) to provide them with enough light to get through the night.

One problem with tapping this power source is that it fluctuates between 5 volts and up to 100 volts. The inventors had to invent means to use this power but maintain a steady flow of current that would not burn out or overload the LEDs. These means are described below.

The present invention uses less energy that a traditional telephone. It solves the problem of being able to provide emergency light without batteries, generators or having to store power in rechargeable batteries or capacitors. It also eliminates the need for unsafe candles that can cause fire. The invention solves the problem of having to have batteries for flashlights, candles for light, and the need to find matches or lighters to light candles in the dark.

The invention can also use this tapped power source for other applications such as driving or operating low-draw devices or mechanical devices. For example, the phone power source may be used to power a low-draw medical device that would require emergency power during a power failure.

The invention may be used as a light source for additional user applications, for example, as a flashlight to locate an item in a poorly lit area.

The invention does not require any batteries, charging or generators. The invention will ran off any working residential telephone line. Due to the current energy crisis, roaming power failures will continue to be a reality. Having a reliable means of light is thus advantageous. The invention uses a power source that most of us are unaware is even there. It is a light source that plugs into your phone line, not the wall outlet. It uses neither batteries nor generators. The invention provides means to provide light when users need it from a power source users pay for every month when they pay their telephone bills.

The lamp of the present invention plugs into a telephone line and utilizes the phone line to supply current for its lighting system. The lamp has a simple circuit that taps the phone line current and then allows the onboard super bright LEDs to use this energy as a source of power.

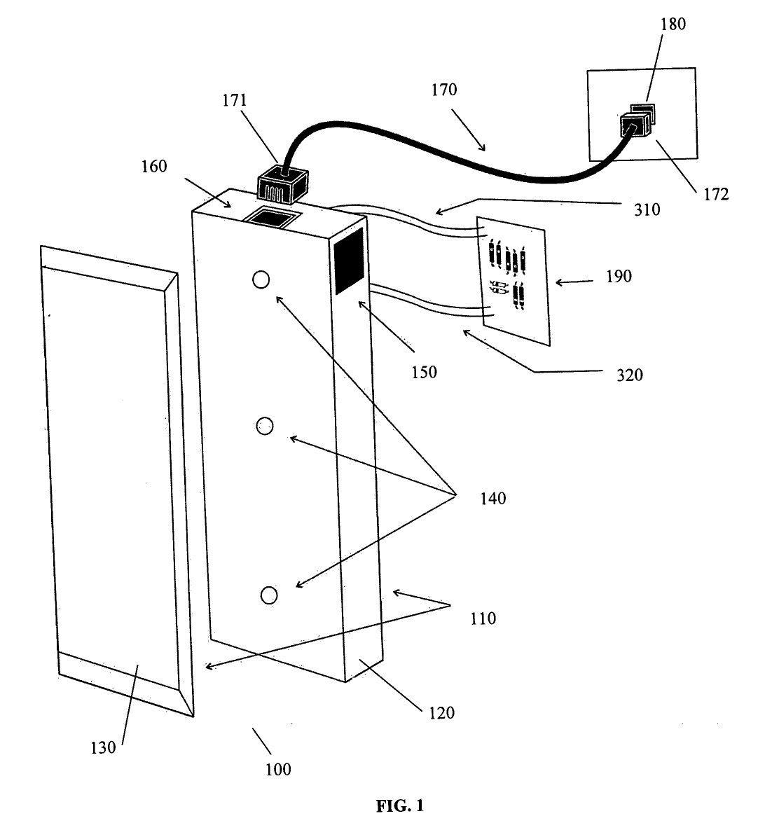

FIG. 1 is an exploded perspective view illustrating a telephone line powered lamp 100 in accordance with an embodiment of the invention. The lamp 100 has a housing 110 consisting of a body 120 and lens cover 130. The lamp 100 includes one or more super bright LEDs 140 mounted on the body 120. The lamp 100 includes an ON/OFF switch 150 mounted on the body 120 for turning the lamp 100 on and off. The lamp 100 includes a connector jack 160 mounted on the body 100 for receiving a connecting telephone cable 170. The telephone cable 170 is used to connect the lamp 100 to an active home telephone line jack (typically wall-mounted) 180. The lamp 100 receives electrical power from the telephone line system through the telephone cable 170. The lamp 100 includes a circuit board 190 (mounted in the housing 110) which is adapted to regulate and control power from the telephone line and provide this power to the LEDs 140 to produce light. The telephone cable 170 may include plugs 171, 172 for inserting into the lamp jack 160 (e.g., RJ-11) and the wall-mounted jack 180 (e.g., RJ-11).

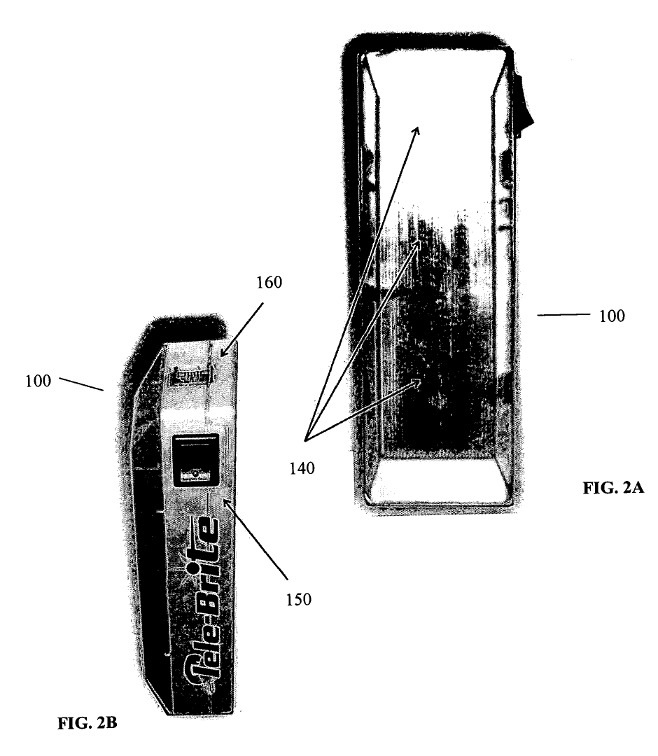

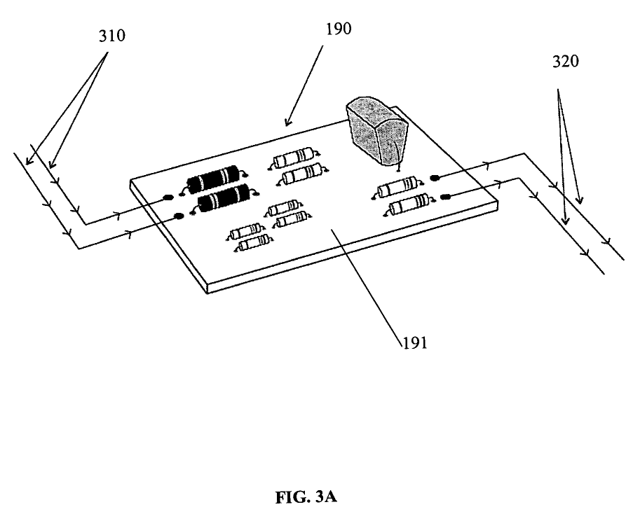

FIGS. 2A and 2B are front and side views, respectively, of the telephone line powered lamp 100 of FIG. 1 in accordance with an embodiment of the invention. The body 120 and lens cover 130 of the lamp 100 may have a variety of shapes. According to one embodiment, the body 120 and lens cover 130 may be combined.

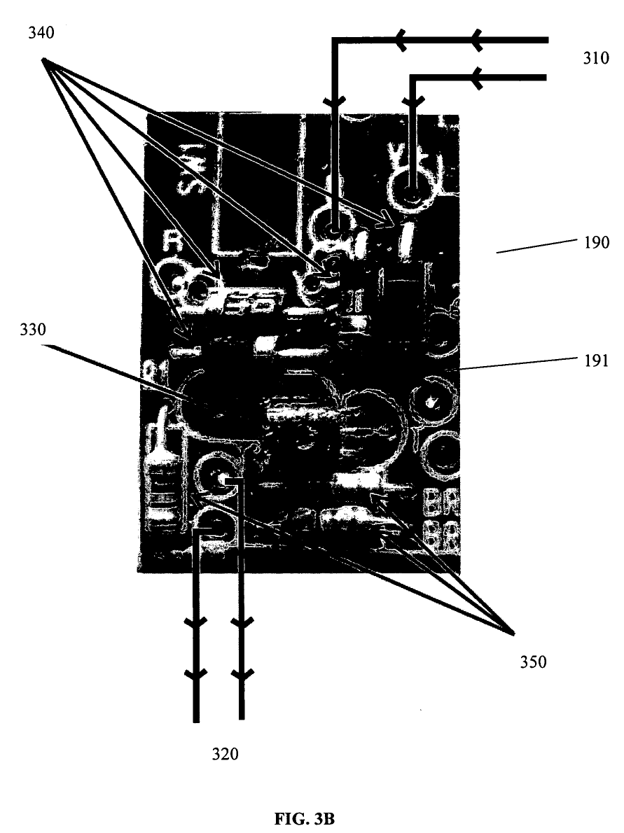

FIG. 3A is a perspective view illustrating a circuit board 190 for the telephone line powered lamp 100 of FIGS. 1 and 2 in accordance with an embodiment of the invention. The circuit board 190 receives fluctuating voltage/current 310 from the telephone line (via the telephone cable 170) and provides a regulated, steady output voltage/current 320 to the LEDs 140. The voltage/current 310 coming in from the telephone line is controlled and regulated to power the LEDs 140 with the correct voltage/current. A circuit 191 contained on the circuit board 190 regulates the telephone line voltage/current to maintain a voltage/current suitable for the LEDs 140 so as not to burn the LEDs 140 out. Since the telephone line voltage my fluctuate anywhere from approximately 9 to 50 to 100 volts at specific times, the circuit 191 is adapted to maintain a continuous lower voltage/current setting that does not widely fluctuate and that can power the LEDs 140 efficiently without burning them out.

FIG. 3B is a plan view illustrating the circuit board 190 in accordance with an embodiment of the invention. The circuit 191 contained on the circuit board 190 includes a regulating diode 330, AC/DC current converting resistors 340, and reduction resistors 350 combined to reduce voltage to 9.5 volts. Unregulated voltage/current 310 from the telephone line enters the circuit 191 and regulated voltage/current 320 is provided to the LEDs 140. Voltage/current 310 entering the circuit 191 from the telephone line is converted (i.e., by resistors 340) to a proper DC voltage. The voltage/current is then feed through a regulating diode 330. From the regulating diode 330, the voltage/current passes through three resistors 350 which reduce the voltage/current down to a suitable level so as not to burn out the LEDs 140.

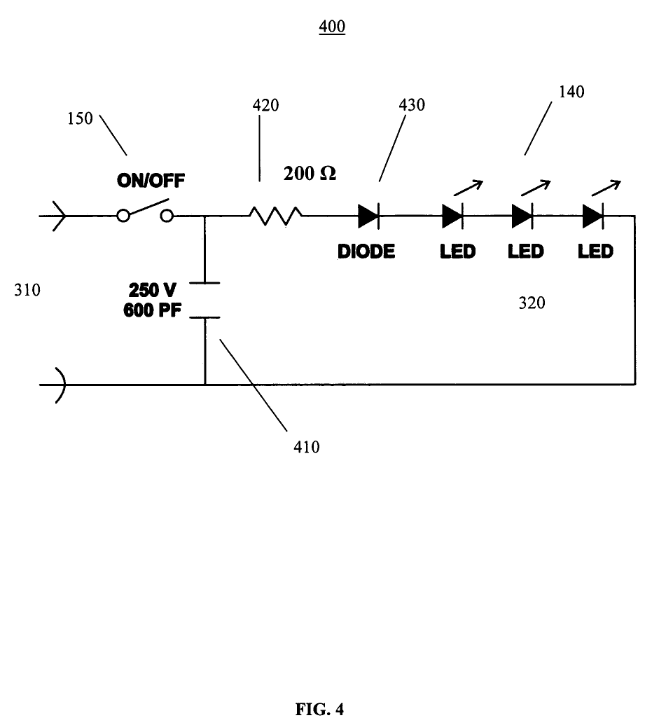

FIG. 4 is a schematic diagram illustrating a circuit 400 on the circuit board 190 of FIGS. 3A and 3B in accordance with an alternate embodiment of the invention. Incoming voltage/current 310 from the telephone line is applied to a capacitor 410 through the ON/OFF switch 150. According to one embodiment, the capacitor 410 is a 250V, 600 pF capacitor. Coupled in series across the capacitor 410, is a resistor 420, a diode 430, and the LEDs 140. According to one embodiment, the resistor 420 is a 200 ohm resistor. The capacitor 410, resistor 420, and diode 430 function to regulate the voltage/current 320 supplied to the LEDs 140.

In operation, a user inserts one end 171 of the telephone cable 170 into the jack 160 on the body 120 of the lamp 100 and the opposite end 171 of the telephone cable 170 into, for example, a wall-mounted jack 180 coupled to the telephone line system. The user operates the ON/OFF switch 150 to supply regulated power 320 to the LEDs 140 to provide light for the user's application. The lamp 100 can be handheld or adapted for wall, floor, or desktop mounting.

Although preferred embodiments of the invention have been described herein, it will be understood by those skilled in the art that variations may be made thereto without departing from the spirit of the invention or the scope of the appended claims.

What is claimed is:

1. A telephone line powered lamp comprising:
a body having mounted thereon one or more light emitting diodes (LEDs);
a lens cover coupled to the body for focusing light from the LEDs;
a telephone jack mounted on the body for receiving a telephone cable for supplying electrical power to the lamp from a telephone line; and,
a circuit board mounted within the body and coupled between the telephone jack and the LEDs for regulating the electrical power supplied to the LEDs from the telephone line.

2. The telephone line powered lamp of claim 1 and further comprising a switch mounted on the body and coupled between the telephone jack and circuit board for switching the electrical power on and off.

3. The telephone line powered lamp of claim 1 wherein the circuit board includes one or more of a regulating diode, AC/DC current converting resistors, and voltage reduction resistors.

4. The telephone line powered lamp of claim 1 wherein the body is adapted for one or more of wall mounting, table mounting, floor mounting, and hand-held operation.

5. The telephone line powered lamp of claim 1 wherein the circuit board includes a capacitor coupled across a series connection of a resistor, a diode, and the LEDs to regulate the electrical power supplied to the LEDs.
